(19) United States
(12) Patent Application Publication
(10) Pub. No.: US 2014/0366671 A1
(43) Pub. Date: Dec. 18, 2014

(54) TRANSMISSION PROTECTION SYSTEM

(71) Applicant: EATON TRUCK COMPONENTS SP. Z O.O., Tezew (PL)

(72) Inventors: Leszek Wulnikowski, Godansk (PL); Zenon Ott, Tczew (PL); Przemyslaw Michalski, Gdansk (PL); Filip Kopylowicz, Tczew (PL)

(73) Assignee: EATON TRUCK COMPONENTS SP. Z O.O., Tczew (PL)

(21) Appl. No.: 14/355,214

(22) PCT Filed: Oct. 31, 2012
(86) PCT No.: PCT/EP2012/071596

§ 371 Date: Apr. 30, 2014

(30) Foreign Application Priority Data
Oct. 31, 2011 (EP) 11460053.9

(51) Int. Cl. F16H 61/18; F16H 59/10

(52) U.S. Cl. CPC F16H 61/18; F16H 59/105
USPC 74/473.21

(57) ABSTRACT

A transmission protection system for a motor vehicle that has a low range of ratios (gears 1, 2, 3 and 4) and a high range of ratios (gears 5, 6, 7 and 8). A selection of gear is made using a gear selection shaft connected with a gear change lever having a preselective switch. An electro-pneumatic valve is directly connected to and acts axially on the gear selection shaft to counteract accidental positioning of the gear selection shaft in a position of the gears 1-2 or in a position of the gears 5-6. An electronic transmission control unit is configured to control the electro-pneumatic valve by an electric signal depending on a difference between a vehicle speed Sᵥ and a first assumed speed S₁ for the low range of ratios or between the vehicle speed Sᵥ and a second assumed speed S₂ for the high range of ratios.

### CROSS-REFERENCE TO PRIOR APPLICATIONS

This application is a U.S. National Phase Application under 35 U.S.C. § 371 of International Application No. PCT/EP2012/071596 filed on Oct. 31, 2012, and claims benefit to European Patent Application No. EP 11460053.9 filed on Oct. 31, 2011. The International Application was published in English on May 10, 2013 as WO 2013/064553 A1 under PCT Article 21(2).

### FIELD

The invention relates to a transmission protection system used in the drivetrain of a motor vehicle. In particular, the invention relates to such transmission which has two ranges of ratio implemented using the additional transmission located in series behind the main transmission equipped with cylindrical gears, wherein at least part of the gears shifting process is realised by means of pneumatic installation using suitable electronically-controlled pneumatic actuators.

### BACKGROUND

The gear transmissions, such as, for example, TRSM0060 gear from EATON, which is a 9-gear transmission used in motor vehicles, are known. This transmission is equipped with front module executing basic ratios via cylindrical gears. The front module comprises a set of four ratios plus crawl and reverse gear. The front module is connected with the rear module, which is a two-gear planetary transmission. Such transmission provides eight (8) basic ratios for driving forwards as well as reverse and crawl gear, four (4) lower gears for driving forwards being provided taking into account lower (reducing) ratio of the planetary transmission and the four higher gear for driving forwards are provided with the direct ratio of the planetary transmission (ratio 1:1). Crawl and reverse gear are provided taking into account lower ratio of the planetary gear.

Within the scope of the front module, the transmission is controlled by means of a device for shifting the gears housed in the transmission casing and equipped with gear selection shaft. This transmission operates in a typical, known “H” arrangement, that consists in that when in neutral position, the selection shaft moves between the position of individual pairs of gears, that are arranged in “H” letter shape. The selection shaft is controlled by means of a gear change lever operated by driver. Pres elective switch enabling selection of ratio range is connected to the gear change lever and enables to select low range of ratios or high range of ratios by selecting one of two ratios of the planetary transmission in the rear module. Selection of one of these ranges can be performed using pneumatic system of motor vehicle in which the transmission is installed. The transmission is equipped with a properly calibrated sensor that enables measurement of vehicle speed. Data from this and other sensors can be transmitted to the electronic controller.

From the description of European application EP1941186, a solution concerning a device for shifting gears in mechanical transmission with a system of transmission ranges and lever providing the gears shifting arrangement in “H” letter array is known, wherein the device for shifting the gears and selection shaft are functionally connected with one end to the lever and with the other to the transmission from the side of moving towards the locking device, that can be activated using pressure of suitable medium, and that prevents or at least warns driver of a motor vehicle about unintentional selection of change of the range group in the transmission, in a manner that passage and selector of shaft, in case of changing the range group, can be moved independently from shifting the position (G5-G6) to the shaft position (G3-G4) from two successive gears to the lowest one (G3, G4).

Said device for shifting gears is designed so that to avoid unwanted changes in case of change of the range group and to enable reduction of gears within a few stages in a manner that changes of the selection shaft position can be moved from one position of the selection shaft (G5-G6) to other position of the selection shaft position (G3-G4) of the following lower gear with different force (F1 to F2) which changes during shifting.

In this solution, gear change lever is equipped with gear range selection switch that is electrically connected with the electronic control unit. The transmission casing houses pneumatic actuator and the change of force on the selection shaft is provided by a cam connected with the constant force pneumatic actuator. Cam is seated on an axle in the transmission casing and transfers pneumatic actuator force changing its direction at right angle. Cam profile causing its cooperation on a variable arm causes the change of force on the selection shaft at constant force of the pneumatic actuator.

Up to now, most of mechanical transmissions haven't comprised an efficient system for protection against accidental attempt to engage too low ratio. The solution presented in EP1941186 is complicated, does not fulfil all expected functionalities and makes the transversal dimension of the transmission larger.

### SUMMARY

In an embodiment, the present invention provides a transmission protection system for a motor vehicle that is equipped with a low range of ratios including at least four ratios (gears 1, 2, 3 and 4) and a high range of ratios including at least four ratios (gears 5, 6, 7 and 8). The motor vehicle comprises a transmission equipped with a pneumatic installation configured to select a ratios range by a preselective switch and a vehicle speed sensor. The transmission protection system includes a device for shifting gears operable in an H letter array, wherein a selection of gear is realisable by a gear selection shaft connected with a gear change lever equipped with the preselective switch to select the low or the high range of ratios. An electro-pneumatic valve is directly connected to and acts axially on the gear selection shaft so as to counteract accidental positioning of the gear selection shaft in a position of the gears 1-2 within the low range of ratios or in a position of the gears 5-6 within the high range of ratios. An electronic transmission control unit is configured to control the electro-pneumatic valve by an electric signal depending on a difference between a vehicle speed Sv and a first assumed speed S1 for the low range of ratios or a difference between the vehicle speed Sv and a second assumed speed S2 for the high range of ratios.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a diagram of an exemplary drivetrain, equipped with the transmission protection system for motor vehicles with electronic transmission control unit;

FIG. 2 represents axial section of the electro-pneumatic valve EPV and partially the device for shifting the gears LRC;

FIG. 3 represents perspective view of the electro-pneumatic valve EPV with partially broken-out section of the device for shifting the gears LRC;

FIG. 4 represents diagram of operation within low range of ratios under normal conditions for Sᵥ lower than S₁;

FIG. 5 represents diagram of operation within low range of ratios under abnormal conditions for Sᵥ higher than S₁;

FIG. 6 represents diagram of operation within high range of ratios under normal conditions for Sᵥ lower than S₂;

FIG. 7 represents diagram of operation within high range of ratios under abnormal conditions for Sᵥ higher than S₂;

FIG. 8 represents diagram of operation during switching from high range of ratios under abnormal conditions for Sᵥ higher than S₁; and

FIG. 9 represents block diagram of protection system with electronic transmission control unit TCU.

### DETAILED DESCRIPTION

In an embodiment, the present invention provides a transmission protection system in the drivetrain of a motor vehicle, such as a motor vehicle equipped with low range of ratios and high range of ratios, comprising a device for shifting gears LRC operating in “H” letter array, wherein the selection of gear is realised by means of the gear selection shaft connected with the gear change lever equipped with the preselective switch [to select low or high range of ratios, and the low range of ratios is equipped with at least four ratios (1, 2, 3, 4) and the high range of ratios is equipped with at least four ratios (5, 6, 7 and 8), the transmission being equipped with pneumatic installation used to select the ratios range by means of the preselective switch and vehicle speed sensor, that at the same time eliminates drawbacks of the prior art.

The transmission protection system for motor vehicles, according to an embodiment of the invention, is related to mechanical transmission equipped with low range of ratios and high range of ratios, comprising a device for shifting gears LRC operating in “H” letter array. The selection of gear is realised by means of the gear selection shaft connected with the gear change lever equipped with the preselective switch to select low or high range of ratios.

Low range of ratios comprises at least four ratios 1, 2, 3, 4 and high range of ratios also comprises at least four ratios 5, 6, 7 and 8.

The transmission is equipped with pneumatic installation used to select the ratios range by means of the preselective switch. The transmission also comprises the vehicle speed sensor.

The gear selection shaft is directly connected with the electro-pneumatic valve EPV acting axially on the gear selection shaft in such a manner, that it counteracts accidental positioning of the gear selection shaft in position of the gears 1-2 within the low range of ratios or in position of the gears 5-6 within the high range of ratios, and the electro-pneumatic valve EPV is controlled by means of the electronic transmission control unit TCU.

The electronic transmission control unit TCU collects the information from the vehicle speed sensor and is programmed with data concerning the first assumed speed S₁ and the second assumed speed S₂ as well as the assumed speed S_{z}. Depending on the difference between the vehicle speed Sᵥ and the first assumed speed S₁ in case of the low range of ratios or difference between the vehicle speed Sᵥ and the second assumed speed S₂ in case of the high range of ratios, the electronic transmission control unit TCU controls the position of the electro-pneumatic valve EPV.

The electro-pneumatic valve EPV comprising the piston housed in the casing of the electro-pneumatic valve EPV is seated on the casing of the gear shifting device LRC, and is directly connected with the gear selection shaft of the gear shifting device LRC of the transmission.

The electronic transmission control unit TCU for the transmission protection system for motor vehicles, according to the invention, wherein the transmission is equipped with low range of ratios and high range of ratios and comprises the device for shifting the gears operating in “H” letter array, wherein the selection of gear is realised by means of the gear selection shaft connected with the gear change lever. The gear change lever is equipped with the preselective switch to select low or high range of ratios.

The low range of ratios comprises at least four ratios 1, 2, 3, 4 and the high range of ratios comprises at least four ratios 5, 6, 7 and 8. The transmission is equipped with pneumatic installation used to select the range of ratios by means of the preselective switch. The transmission is also equipped with the vehicle speed sensor.

The transmission control unit TCU is connected with the vehicle speed sensor and the transmission is equipped with the electro-pneumatic valve EPV acting axially on the gear selection shaft of the device for shifting the gears LRC. The position of the electro-pneumatic valve EPV is controlled by means of the electronic transmission control unit TCU depending on the difference between the vehicle speed Sᵥ and the first assumed speed S₁ for the low range of ratios or the difference between the vehicle speed Sᵥ and the second assumed speed S₂ for the high range of ratios.

Preferably, the transmission is equipped with a position sensor of the preselective switch for selecting low or high range of ratios, the transmission control unit TCU being connected with the position sensor of the preselective switch, and depending on the position of such switch and the difference between the vehicle speed Sᵥ and the first assumed speed S₁ controls the position of the electro-pneumatic valve EPV.

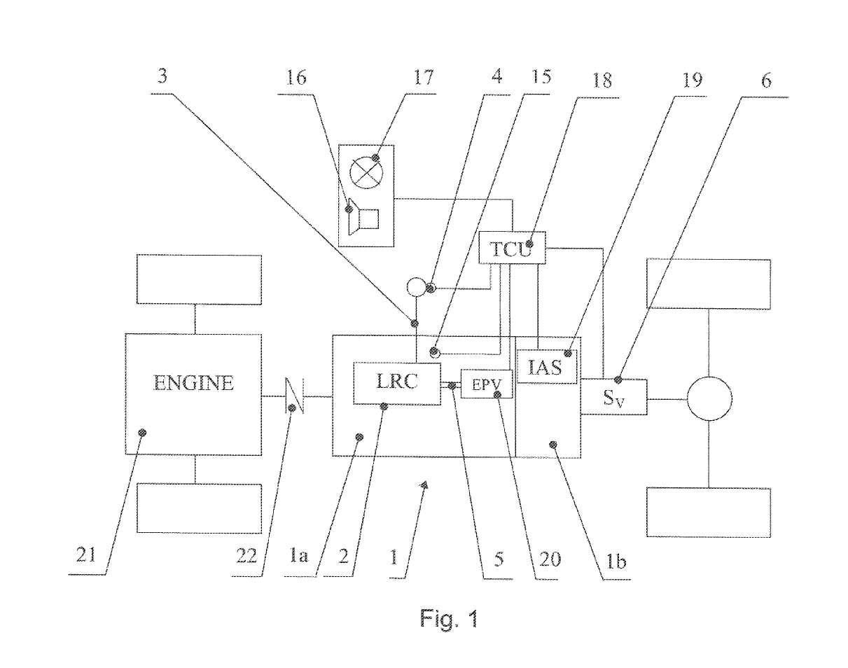

As schematically shown in FIG. 1, a drivetrain of motor vehicle is equipped with a combustion engine 21 that transfers power to the next section of the drivetrain by means of a typical friction clutch 22. The combustion engine is connected via friction clutch with a mechanical transmission 1, from which the drive is transferred using the main transmission in the live axle to road wheels of motor vehicle.

Power from the combustion engine must be transferred to road wheels depending on the current conditions of vehicle movement, with proper ratio that is provided by the mechanical transmission 1 with typical, known gears.

Depending on the purpose, such transmission 1 is equipped with a suitable number of ratios. In the case of motor vehicles such as for example trucks, transmissions with a lot of ratios are used in order to enable the proper matching of ratio to current demand for power on the vehicle wheels.

According to this embodiment of the invention, the transmission comprises a front module 1a equipped with 4 gears for driving forwards within low range of ratios and four gears for driving forwards within high range of ratios. Thus the transmission is equipped with 8 primary gears for driving forwards gears 1, 2, 3 and 4 within the low range of ratios and gears 5, 6, 7 and 8 within the high range of ratios. According to this embodiment, transmission 1 is equipped with additional crawl gear for driving forwards and reverse gear.

The low and high range of ratios is realised by the rear module 1b which is a planetary gear that constitutes a common assembly with the transmission 1 that enables to obtain two ratios: direct ratio and reduction ratio. The reduction ratio realises the low range of ratios, i.e. gears 1, 2, 3 and 4 and the direct ratio realises the high range of ratios, i.e. gears 5, 6, 7 and 8.

To select proper ratio, the transmission 1 is equipped with device LRC for shifting the gears 2. The gear shifting device 2 operates in “H” letter array, which means that between the position of gear 1-2 within the low range of ratios (5-6 within high range of ratios) and 3-4 within the low range of ratios (7-8 within high range of ratios) there is “an idle” position that extends perpendicularly with respect to the above mentioned positions of gear selection.

According to the above mentioned diagram of operation of the transmission 1, it thus comprises 4 pairs of gear wheels that provide the primary gears for driving forwards, and the low and high range of positions is realised by the planetary gear in the rear module 1b. In other words, gear 1 within the low range of ratios and gear 5 within the high range of ratios is realised by the same pair of gear wheels in the transmission 1, gears 2 and 6 are realised by the next pair and so one.

Selection of gear in the transmission is realised by the gear selection shaft 5 connected with the gear shift lever 3 operated by driver. Gear change lever 3 is equipped with preselective switch 4 that via electronic route transmits a signal to the electronic transmission control unit TCU 18, which will be discussed later in more detail.

The preselective switch 4 is used to set the planetary gear ratio in the rear module lb and thus to select low range of gears for the increasing ratio of the planetary gear or high range of gears for direct ratio of the planetary gear.

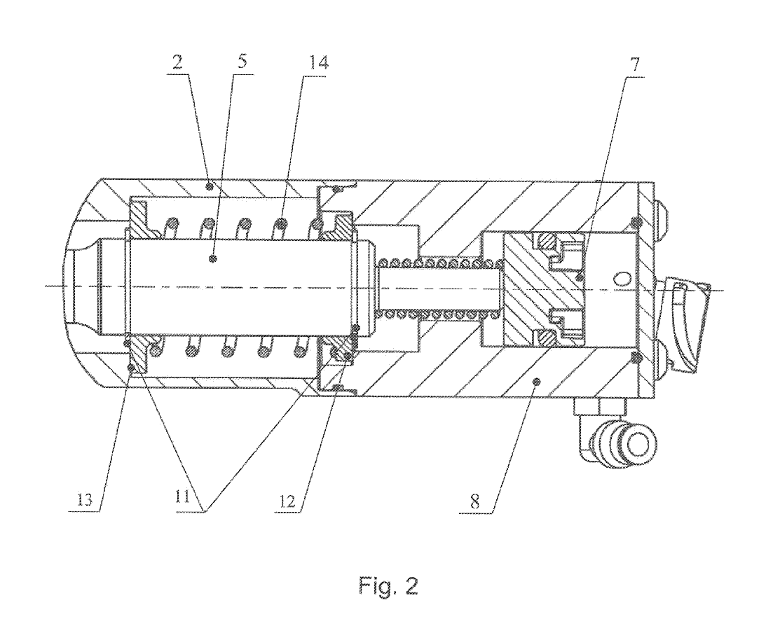

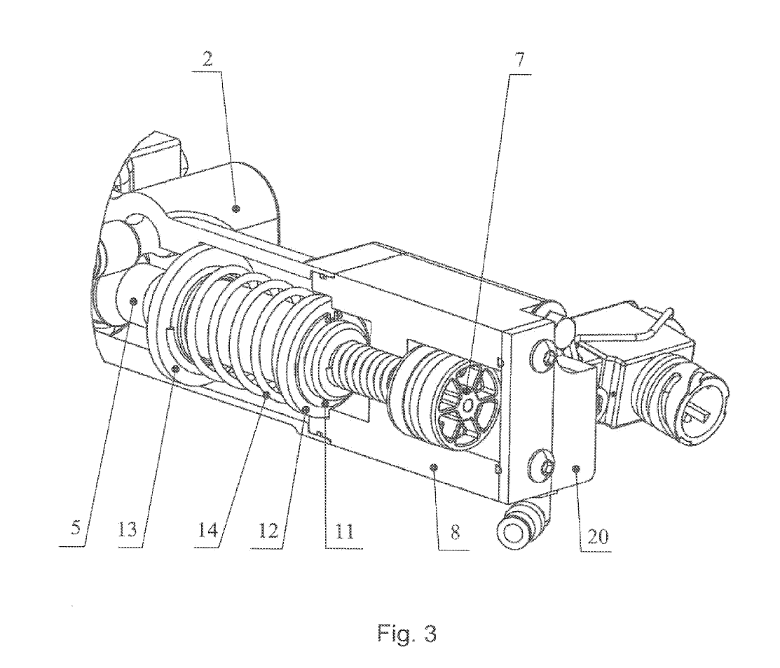

As shown in FIG. 2 and FIG. 3, in the transmission protection system 1 for motor vehicles, the gear selection shaft 5 in the device LRC for shifting the gears 2 is directly connected with an electro-pneumatic valve EPV 20 housed in the casing of the device LRC for shifting the gears 2. The transmission protection system 1 for motor vehicles is equipped with an electronic transmission control unit TCU 18 to which the signals of the plurality of parameters related to vehicle motion or present status of respective assemblies of the transmission 1 are transmitted. These signals include, among other things, current speed of vehicle that is shown by the speed sensor Sᵥ 6 arranged on the transmission 1. The electronic transmission control unit TCU 18 is programmed with the values used to compare present parameters with these programmed data and respectively to the actual status of transmitting the signals to the elements of the transmission protection system 1 for motor vehicles. These programmed values include among other things the first assumed speed S₁, the second assumed speed S₂ or the assumed speed S_{z}.

The electro-pneumatic valve EPV 20 comprises a piston 7 housed in the casing 8 of the electro-pneumatic valve EPV 20, that is seated on the casing of the gear shifting device LRC 2. The gear selection shaft 5 extends from the casing of the gear shifting device LRC 2 into the housing 8 of the electro-pneumatic valve EPV 20. The outer end of the gear selection shaft 5 having a reduced diameter is in direct contact with the piston 7 of the electro-pneumatic valve EPV 20.

The gear selection shaft 5 from the side of the electro-pneumatic actuator EPV has a substantially smaller diameter, and within this section of the gear selection shaft 5 of smaller diameter, a damper spring 10 is seated.

On the wider section of the gear selection shaft 5, there are circlips 11 installed and between the circlips 11, the following elements are installed: from the side of the electro-pneumatic actuator EPV, sliding spring cup 12 and from the side of transmission 1, auxiliary spring cup 13. Between the sliding spring cup 12 and auxiliary spring cup 13 the main spring is installed 14, the sliding spring cup 12 and auxiliary spring cup 13 limiting the movement of the gear selection shaft 5 along the electro-pneumatic actuator EPV.

The electro-pneumatic valve EPV 20 is controlled by the electronic transmission control unit TCU 18 in such a manner, that as a result of comparing the vehicle speed Sᵥ and the first assumed speed S₁ for the low range of ratios or for the difference between the vehicle speed Sᵥ and the second assumed speed S₂ for the high range of ratios, it supplies the electro-pneumatic valve EPV 20 with electrical signal or not.

In case of too high speed of the vehicle to select a lower gear, for example from the fourth to first gear, what could lead to damage of the transmission 1, the electronic transmission control unit TCU 18 transmits the electric signal to the electro-pneumatic valve EPV 20 and pressure is supplied to the piston 7 arranged in the casing of the electro-pneumatic valve EPV 20. Piston 7 is shifted towards the gear selection shaft 5. This leads to significant “hindering” of moving the gear selection shaft 5 by driver via the gear change lever 3. Throwing incorrect gear necessitates overcoming additional force on the piston 7 of the electro-pneumatic valve EPV 20 that results from the air pressure in the pneumatic installation. This force is a few times higher than in the case of absence of pressure in the electro-pneumatic valve EPV 20.

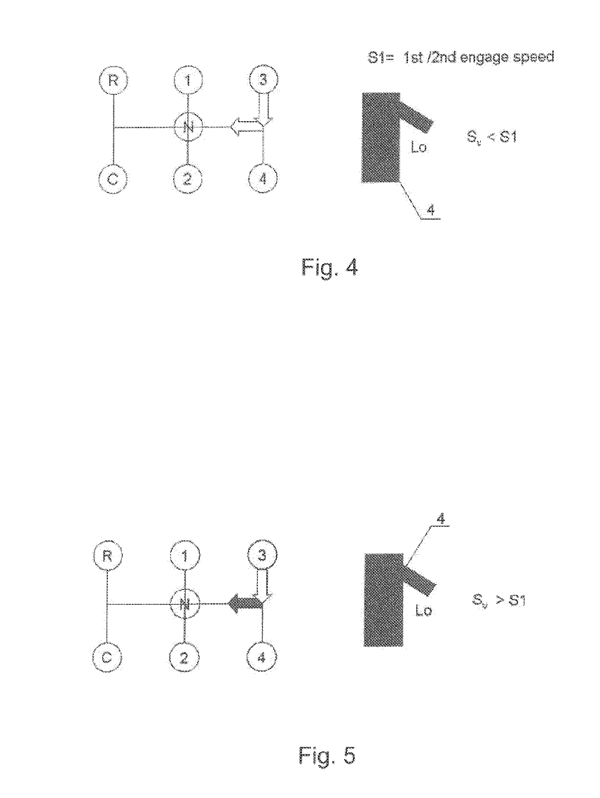

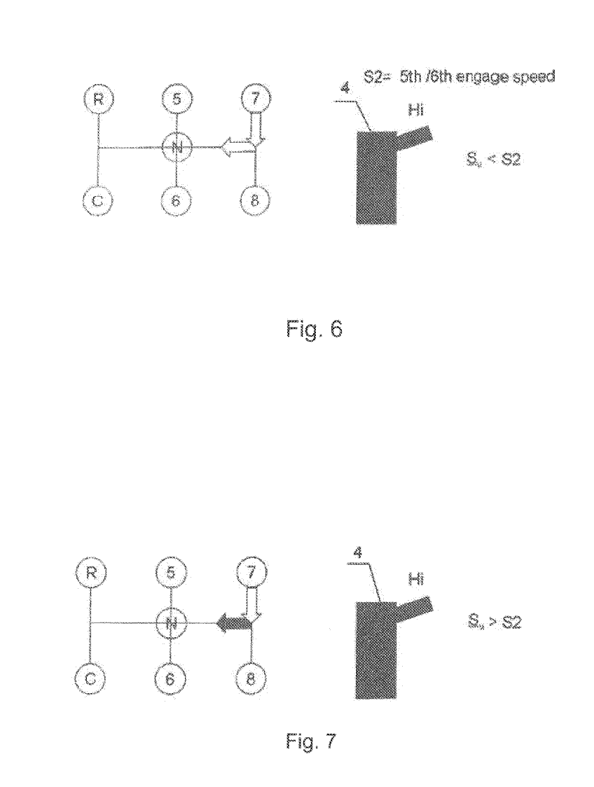

Accordingly, the situation for normal conditions is illustrated in FIG. 4 for low range of ratios, and in FIG. 6 for high range of ratios, wherein in case of vehicle speed Sᵥ lower than the first assumed speed S₁ while shifting the gear from 3 to 2 for the low range of ratios and S₂ while shifting the gear from 7 to 6 for the high range of ratios, the force of shifting from gear 3-4 position (7-8) to position 1-2 (5-6) is not increased and it results from the main spring 14 force in device for shifting gears LRC 2.

Accordingly, the situation under abnormal conditions is illustrated in FIG. 5 for low range of ratios and in FIG. 7 for high range of ratio, wherein in the case of vehicle speed Sᵥ higher than the first assumed speed S₁ while shifting the gear from 3 to 2 for the low range of ratios and S₂ while shifting the gear from 7 to 6 for the high range of ratios, the force of shifting from gear 3-4 position (7-8) to position 1-2 (5-6) is a few times increased and it results from the main spring 14 force and the air pressure from the pneumatic installation in the electro-pneumatic valve EPV 20.

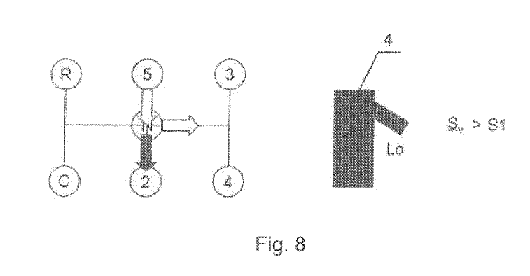

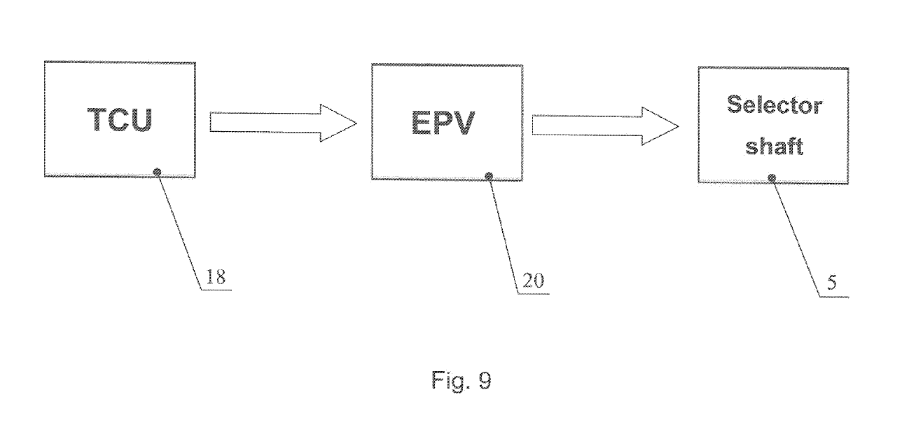

FIG. 8 illustrates the situation, when the driver would like to shift directly the gear from 5 within the high range of ratios to 2 within the low range of ratios using the preselective switch 4 at the vehicle speed Sᵥ higher than the assumed speed S₁. In this situation, increased force of the electro-pneumatic valve EPV 20 will cause the gear selection shaft 5 to be pushed into the position of gears 3-4 within the low range of ratios.

The transmission is equipped with a position sensor 15 of the preselective switch 4 for selecting low or high range of ratios, as it is shown in FIG. 1, the transmission control unit TCU 18 being connected with the position sensor 15 of the preselective switch 4, and depending on the position of this switch and the difference between the vehicle speed Sᵥ and the first assumed speed S₁ or the second assumed speed S₂, controls the position of the electro-pneumatic valve EPV 20.

The transmission is equipped with pneumatic installation used to select the range of ratios by means of the preselective switch 4 and vehicle speed sensor 6, as well as position sensor of the preselective switch 15 for selecting the low or high range of ratios.

The transmission control unit TCU 18 is connected with the vehicle speed sensor 6 and the transmission is equipped with the electro-pneumatic valve EPV 20 that acts axially on the gear selection shaft 5, the position of the electro-pneumatic valve EPV 20 being controlled by the electronic transmission control unit TCU 18 depending on the difference between the vehicle speed Sᵥ and the first assumed speed S₁ for the low range of ratios or the difference between the vehicle speed Sᵥ and the second assumed speed S₂ for the high range of ratios, as it as mentioned above.

It is obvious for one of ordinary skill in the art, that the invention is not limited to the embodiments presented herein and can be modified according to the claims.

In the present description, specific terms were used to define particular elements of the system, however these are used only for general and descriptive purposes and they are not limiting.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A transmission protection system for a motor vehicle equipped with a low range of ratios including at least four ratios (gears 1, 2, 3 and 4) and a high range of ratios including at least four ratios (gears 5, 6, 7 and 8), the motor vehicle comprising a transmission equipped with a pneumatic installation configured to select a ratios range by a preselective switch and a vehicle speed sensor, the transmission protection system comprising:
a device for shifting gears operable in an H letter array, wherein a selection of gear is realisable by a gear selection shaft connected with a gear change lever equipped with the preselective switch to select the low or the high range of ratios/.
an electro-pneumatic valve directly connected to and acting axially on the gear selection shaft so as to counteract accidental positioning of the gear selection shaft in a position of the gears 1-2 within the low range of ratios or in a position of the gears 5-6 within the high range of ratios; and
an electronic transmission control unit configured to control the electro-pneumatic valve by an electric signal depending on a difference between a vehicle speed Sᵥ and a first assumed speed S₁ for the low range of ratios or a difference between the vehicle speed Sᵥ and a second assumed speed S₂ for the high range of ratios.

2. The transmission protection system according to claim 1, wherein the gear selecting shaft is in physical contact with the electro-pneumatic valve.

3. The transmission protection system according to claim 1, wherein the electro-pneumatic valve includes a piston housed in a casing of the electro-pneumatic valve which is seated on a casing of the gear shifting device.

4. The transmission protection system according to claim 1, wherein the transmission is equipped with a positions sensor of the preselective switch for selecting the low or the high range of ratios, the transmission control unit being connected with the position sensor of the preselective switch and being configured to control a position of the electro-pneumatic valve depending on a position of the preselective switch and the difference between the vehicle speed Sᵥ and the first assumed speed S₁ or the second assumed speed S₂.

5. The transmission protection system according to claim 1, wherein the electro-pneumatic valve is configured to prevent engagement of gear 2 from gear 5, by the electro-pneumatic valve acting axially and directly on the gear selection shaft while disengaging the gear 5 so as to cause the gear selection shaft to be pushed into a position of gears 3-4.
